(19) United States
(12) Patent Application Publication
(10) Pub. No.: US 2024/0346811 A1
(43) Pub. Date: Oct. 17, 2024

(54) METHOD, APPARATUS, DEVICE AND STORAGE MEDIUM FOR FEATURE AGGREGATION

(71) Applicant: Beijing Youzhuju Network Technology Co., Ltd., Pinggu District (CN)

(72) Inventors: Quan Cui, Beijing (CN); Muyang Yi, Beijing (CN); Hao Wu, Beijing (CN); Cheng Yang, Beijing (CN)

(21) Appl. No.: 18/609,182

(22) Filed: Mar. 19, 2024

(30) Foreign Application Priority Data
Apr. 13, 2023 (CN) 202310396909.2

(51) Int. Cl. G06V 10/80; G06V 10/26; G06V 10/764; G06V 10/77

(52) U.S. Cl. CPC G06V 10/806; G06V 10/26; G06V 10/764; G06V 10/7715

(57) ABSTRACT

Embodiments of the disclosure provide a method, apparatus, device and storage medium for feature aggregation. The method comprises: extracting, with an image encoder, an image feature representation of an input image; for each image feature element set of a plurality of image feature element sets divided along a predetermined dimension of the plurality of dimensions in the image feature representation, selecting a first number of image feature elements from the image feature element set based on a ranking of corresponding image feature elements in the image feature element set, and determining an aggregated image feature element by aggregating the selected first number of image feature elements; and determining an aggregated image feature representation of the input image based on a plurality of aggregated image feature elements determined for the plurality of image feature element sets, respectively.

### CROSS-REFERENCE

This application claims priority to Chinese Patent Application No. 202310396909.2, filed on Apr. 13, 2023, the entirety of which is incorporated herein by reference.

### FIELD

Example embodiments of the present disclosure generally relate to the field of computers, and in particular to a method, apparatus, device, and computer readable storage medium for feature aggregation.

### BACKGROUND

Feature aggregation is the process of obtaining a feature based on multiple features. It is an important step for the encoder to perform feature extraction tasks. The result of feature aggregation may be, for example, a feature vector formed by aggregating multiple features. The method used to perform feature aggregation can be based on aggregation functions. Commonly used aggregate functions may be, for example, average aggregate function (AVG), maximum aggregate function (MAX), minimum aggregate function (MIN), sum aggregate function (SUM), etc.

### SUMMARY

In a first aspect of the present disclosure, a method for feature aggregation is provided. The method comprises: extracting, with an image encoder, an image feature representation of an input image, the image feature representation corresponding to a plurality of image patches of the input image, and image feature elements of the image feature representation being logically organized in a plurality of dimensions; for each image feature element set of a plurality of image feature element sets divided along a predetermined dimension of the plurality of dimensions in the image feature representation, selecting a first number of image feature elements from the image feature element set based on a ranking of corresponding image feature elements in the image feature element set, and determining an aggregated image feature element by aggregating the selected first number of image feature elements; and determining an aggregated image feature representation of the input image based on a plurality of aggregated image feature elements determined for the plurality of image feature element sets, respectively.

In a second aspect of the present disclosure, an apparatus for feature aggregation is provided. The apparatus comprises: an image feature extraction unit configured for extracting, with an image encoder, an image feature representation of an input image, the image feature representation corresponding to a plurality of image patches of the input image, and image feature elements of the image feature representation being logically organized in a plurality of dimensions; an image feature processing unit configured for, for each image feature element set of a plurality of image feature element sets divided along a predetermined dimension of the plurality of dimensions in the image feature representation, selecting a first number of image feature elements from the image feature element set based on a ranking of corresponding image feature elements in the image feature element set, and determining an aggregated image feature element by aggregating the selected first number of image feature elements; and an aggregated image feature determination unit configured for determining an aggregated image feature representation of the input image based on a plurality of aggregated image feature elements determined for the plurality of image feature element sets, respectively.

In a third aspect of the present disclosure, an electronic device is provided. The device includes at least one processing unit; and at least one memory coupled to the at least one processing unit and storing instructions for execution by the at least one processing unit. The instructions, when executed by the at least one processing unit, cause the electronic device to perform the method of the first aspect.

In a fourth aspect of the present disclosure, a computer readable storage medium is provided. A computer readable storage medium has stored thereon a computer program, when executed by a processor, implementing the method of the first aspect.

It should be understood that what is described in this Summary is not intended to define key features or important features of the embodiments of the disclosure, nor is it intended to limit the scope of the disclosure. Other features of the present disclosure will become readily apparent from the description below.

### BRIEF DESCRIPTION OF THE DRAWINGS

The above and other features, advantages and aspects of various embodiments of the present disclosure will become more apparent with reference to the following detailed description taken in conjunction with the accompanying drawings. In the drawings, the same or similar reference numeral represents the same or similar elements, where:

FIG. 1 illustrates a schematic diagram of an example environment in which embodiments of the present disclosure can be implemented;

FIG. 2 illustrates a schematic diagram of model pre-training of the Contrastive Language-Image Pre-training (CLIP) model;

FIG. 3 illustrates a schematic diagram of an architecture for feature aggregation according to some embodiments according to the present disclosure;

FIG. 4 illustrates a schematic diagram of an architecture for image segmentation according to some embodiments of the present disclosure;

FIG. 5 illustrates a flowchart of a process for feature aggregation according to some embodiments of the present disclosure;

FIG. 6 illustrates a schematic structural block diagram of an apparatus for feature aggregation according to some embodiments of the present disclosure; and

FIG. 7 illustrates a block diagram of an electronic device that may implement one or more embodiments of the present disclosure.

### DETAILED DESCRIPTION

Embodiments of the present disclosure will be described in more detail below with reference to the accompanying drawings. Although some embodiments of the present disclosure are shown in the drawings, it would be appreciated that the present disclosure can be implemented in various forms and should not be interpreted as limited to the embodiments described herein. On the contrary, these embodiments are provided for a more thorough and complete understanding of the present disclosure. It would be appreciated that the drawings and embodiments of the present disclosure are only for illustrative purposes and are not intended to limit the scope of protection of the present disclosure.

In the description of the embodiments of the present disclosure, the term “including” and similar terms should be understood as open-ended inclusion, that is, “including but not limited to”. The term “based on” should be understood as “at least partially based on”. The terms “one embodiment” or “the embodiment” should be understood as “at least one embodiment”. The term “some embodiments” should be understood as “at least some embodiments”. The following may also include other explicit and implicit definitions. As used herein, the term “model” may represent an association between various data. For example, the above correlation relationship can be obtained based on various technical solutions that are currently known and/or will be developed in the future.

It is to be understood that, before applying the technical solutions disclosed in various implementations of the present disclosure, the user should be informed of the type, scope of use, and use scenario of the personal information involved in the subject matter described herein in an appropriate manner in accordance with relevant laws and regulations, and user authorization should be obtained.

It is to be understood that, before applying the technical solutions disclosed in various implementations of the present disclosure, the user should be informed of the type, scope of use, and use scenario of the personal information involved in the subject matter described herein in an appropriate manner in accordance with relevant laws and regulations, and user authorization should be obtained.

For example, in response to receiving an active request from the user, prompt information is sent to the user to explicitly inform the user that the requested operation would acquire and use the user's personal information. Therefore, according to the prompt information, the user may decide on his/her own whether to provide the personal information to the software or hardware, such as electronic devices, applications, servers, or storage media that execute operations of the technical solutions of the subject matter described herein.

As an optional but non-limiting implementation, in response to receiving an active request from the user, the way of sending the prompt information to the user may, for example, include a pop-up window, and the prompt information may be presented in the form of text in the pop-up window. In addition, the pop-up window may also carry a select control for the user to choose to “agree” or “disagree” to provide the personal information to the electronic device.

It is to be understood that the above process of notifying and obtaining the user authorization is only illustrative and does not limit the implementations of the present disclosure. Other methods that satisfy relevant laws and regulations are also applicable to the implementations of the present disclosure.

As used herein, the term “model” may learn the correlation relationship between corresponding inputs and outputs from training data, so that corresponding outputs may be generated for given inputs after training. The generation of the model may be based on machine learning technology. Deep learning is a machine learning algorithm that processes inputs and provides corresponding outputs by using a plurality of layers of processing units. Neural networks models are an example of deep learning-based models. Herein, “model” may also be referred to as “machine learning model”, “learning model”, “machine learning network”, or “learning network”, and these terms are used interchangeably herein.

A “neural network” is a machine learning network based on deep learning. Neural networks are capable of processing inputs and providing corresponding outputs, and typically include an input layer and an output layer and one or more hidden layers between the input layer and the output layer. Neural networks used in deep learning applications often include many hidden layers, thereby increasing the depth of the network. The layers of a neural network are connected in sequence such that the output of the previous layer is provided as the input of the subsequent layer, where the input layer receives the input of the neural network, and the output of the output layer serves as the final output of the neural network. Each layer of a neural network includes one or more nodes (also referred to as processing nodes or neurons), each of which processes input from the previous layer.

Generally, machine learning may roughly include three stages, namely a training stage, a testing stage and an application stage (also referred to as an inference stage). In the training stage, a given model may be trained using a large amount of training data, and parameter values are continuously updated iteratively until the model may obtain consistent inferences from the training data that meet the expected goals. Through training, the model may be thought of as being able to learn associations from inputs to outputs (also referred to as input-to-output mappings) from the training data. The parameter values of the trained model are determined. In the testing stage, test inputs are applied to the trained model to test whether the model may provide the correct output, thereby determining the performance of the model. In the application stage, the model may be used to process the actual input and determine the corresponding output based on the parameter values obtained through training.

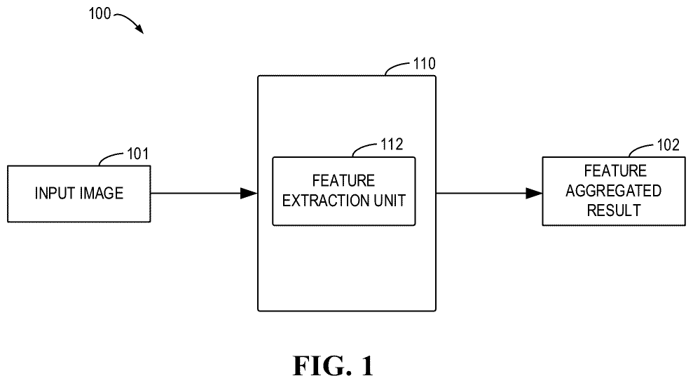

FIG. 1 illustrates a schematic diagram of an example environment 100 in which embodiments of the present disclosure may be implemented. As shown in FIG. 1, the example environment 100 may include an electronic device 110.

In this example environment 100, the electronic device 110 may implement feature extraction and feature aggregation through a trained feature extraction model 112. In some embodiments, after the electronic device 110 obtains an input image 101, the input image 101 is input into the feature extraction model 112. The feature extraction model 112 may then obtain a feature aggregated result 102 corresponding to the input image 101. In some embodiments, during a training stage of the model, the feature extraction model 112 may perform model fine-tuning based on the feature aggregated result 102.

The input image 101 may be, for example, any image in any format (e.g., JPG format, PNG format, WEBP format, etc.), any size, any color (e.g., color image, black and white image, grayscale image), etc. The feature aggregated result 102 may be, for example, but is not limited to a feature vector, a feature matrix, a feature map, etc., associated with the input target.

The feature extraction model 112 may be, for example, any neural network that may perform feature extraction and feature aggregation, including but not limited to Fully Convolutional Network (FCN), Convolutional Neural Network (CNN), Recurrent Neural Network (RNN), etc., and the embodiments of the present disclosure are not restricted in this regard. In some embodiments, the feature extraction model 112 may be stored locally on the electronic device 110. The electronic device 110 may directly utilize the local feature extraction model 112 to implement feature extraction and feature aggregation when it needs to perform tasks associated with feature extraction and feature aggregation. In some embodiments, the feature extraction model 112 may also be a model stored in the cloud. The electronic device 110 may send the input image 101 to the feature extraction model 112 in the cloud and obtain the feature aggregated result 102 from the feature extraction model 112 in the cloud when it needs to perform related tasks.

The electronic device 110 may be any type of computing-capable device, including a terminal device or a server device. The terminal device may be any type of mobile terminal, fixed terminal, or portable terminal, including mobile phones, desktop computers, laptop computers, notebook computers, netbook computers, tablet computers, media computers, multimedia tablets, personal communication system (PCS) devices, personal navigation devices, personal digital assistants (PDAs), audio/video player, digital cameras/camcorders, positioning devices, television receivers, radio broadcast receivers, electronic book devices, gaming devices, or any combination of the foregoing, including accessories and peripherals of these devices, or any combination thereof. Server devices may include, for example, computing systems/servers, such as mainframes, edge computing nodes, computing devices in cloud environments, and the like.

It should be understood that the structure and functionality of environment 100 are described for illustrative purposes only, without implying any limitation on the scope of the present disclosure.

The traditional feature aggregation solution may, for example, directly aggregate all extracted features. During the training stage of the model, if there are multi-modal features, the aggregated features obtained by aggregating each modality in the multi-modal features may be used to calculate a contrastive learning loss (InfoNCE), and the contrastive learning loss may be used to adjust the parameters of the encoder in the model.

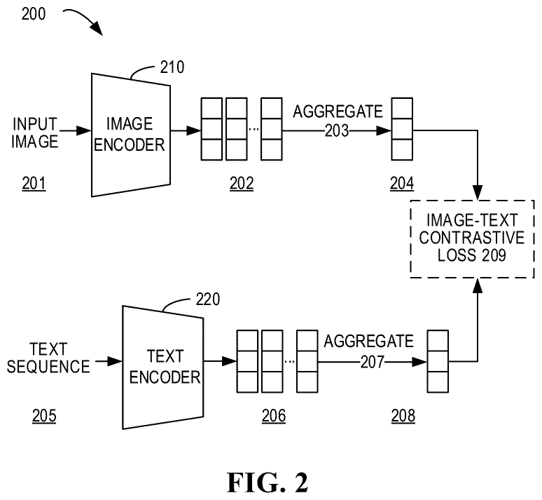

FIG. 2 illustrates a schematic diagram of model pre-training of the CLIP model according to a traditional scheme.

As shown in FIG. 2, sample data in a pre-training stage includes a sample image-text pair, and an input image 201 and a text sequence 205 in the sample image-text pair are input into an image encoder 210 and a text encoder 220, respectively. The image encoder 210 may extract an image feature representation 202 of the input image 201, and the text encoder 220 may extract a text feature representation 206 of the text sequence 205. It should be noted that since the image encoder 210 and text encoder 220 of the CLIP model are both encoders based on the transformer structure, the feature representation extracted is a feature representation for a token. For image, each token may correspond to one image patch. For the text, each token may correspond to one text unit.

By aggregating 203 the image feature representation 202, for example using an aggregation function or other appropriate aggregation operations, an aggregated image feature representation 204 may be obtained. By aggregating 207 the text feature representation 206, an aggregated text feature representation 208 may be obtained. The aggregation 207 of the text feature representation 206 may also be completed using an aggregation function or other appropriate aggregation operations, for example. The aggregated image feature representation 204 and the aggregated text feature representation 208 may be used to calculate image-text contrastive loss 209. Specifically, the loss function may be used to calculate the aggregated image feature representation 204 and aggregated text feature representation 208 corresponding to all sample data, and the result obtained is the contrastive learning loss between the two, that is, the image-text contrastive loss 209. The loss function may be, for example, the L2 loss function, the L1 loss function, the Smooth L1 loss function, the huber loss function, the softmax loss function, etc.

The parameters of image encoder 210 and text encoder 220 may be adjusted based on the calculation results of the loss function (i.e., image-text contrastive loss 209). The learning goals of image encoder 210 and text encoder 220 are to increase the similarity of positive sample pairs and reduce the similarity of negative sample pairs.

It should be noted that since the background elements of input image 201 account for a relatively high proportion in the input image 201, the aggregated image feature representation 204 obtained by directly aggregating all image feature representation 202 will be dominated by the background elements of input image 201, which will make the entire model insensitive to changes in the foreground objects of input image 201.

As mentioned before, directly aggregating the features output by the encoder will cause the model to be insensitive to the foreground objects of the image, which will directly affect the effect of image segmentation, causing the segmentation results to be unable to accurately express the foreground objects, which in turn leads to inaccuracy in output the segmentation map, affecting the effect of subsequent image processing.

According to example embodiments of the present disclosure, an improved scheme for feature aggregation is provided. According to this scheme, an image feature representation of an input image may be extracted with an image encoder. For each image feature element set of a plurality of image feature element sets in the image feature representation, a first number of image feature elements are selected from each image feature element set, and an aggregated image feature element is determined by aggregating them. An aggregated image feature representation of the input image is determined based on a plurality of aggregated image feature elements determined for the plurality of image feature element set, respectively. In this way, the aggregated image feature representation obtained by feature aggregation may be made more sensitive to the foreground elements in the input image, thereby improving the accuracy of the aggregated features, and also improving the segmentation effect of subsequent image segmentation in the model application stage.

Some example embodiments of the present disclosure will continue to be described below with reference to the accompanying drawings.

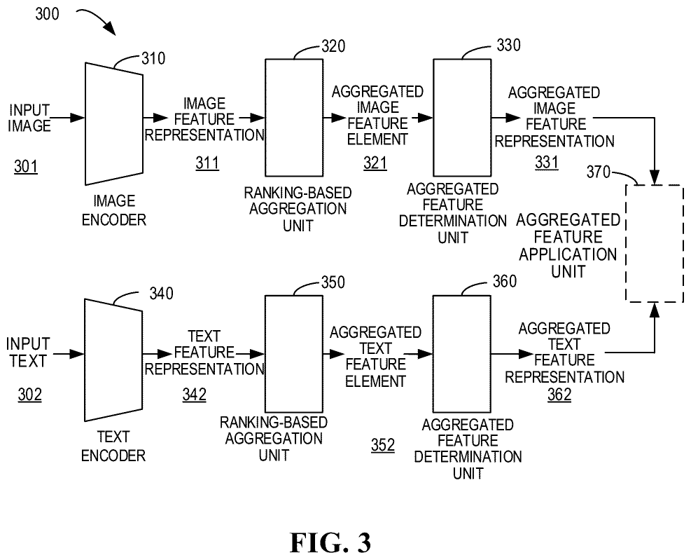

FIG. 3 illustrates a schematic diagram of an architecture 300 for feature aggregation according to some embodiments of the present disclosure. The architecture 300 may be implemented at the electronic device 110 in FIG. 1, and various units and/or encoders in the architecture 300 may be implemented by or utilizing the feature extraction model 112 of FIG. 1. For case of discussion, the architecture 300 will be described with reference to the environment 100 in FIG. 1.

As shown in FIG. 3, the architecture 300 includes an image encoder 310, a ranking-based aggregation unit 320, an aggregated feature determination unit 330, a text encoder 340, a ranking-based aggregation unit 350 and an aggregated feature determination unit 360. An input image 301 is provided to the image encoder 310, and the image encoder 310 may extract an image feature representation 311 of the input image 301. Herein, “feature representation” (referred to as “feature”) is sometimes also referred to as an encoded representation, a vector representation, etc. In some embodiments, the image feature representation 311 may characterize a color, texture, shape of objects in the image, and/or other properties of the image.

The image encoder may be implemented based on one or more Transformer blocks or various variations of Transformer blocks. Alternatively, or additionally, in addition to the Transformer block, the image encoder may be based on other types of models or neural networks, such as Unet architecture, SegNet architecture, Fully Convolutional Network (FCN), Convolutional Neural Network (CNN), Recurrent Neural Network (RNN), etc. The specific type of model structure may be selected according to actual application needs, and there are no restrictions here. The image feature representation 311 output by the image encoder 310 corresponds to a plurality of image patches of the input image 301, and image feature elements of the image feature representation 311 are logically organized in a plurality of dimensions. The image feature elements are logically organized in a plurality of dimensions, for example, they may be ranked and combined according to the plurality of dimensions. The image feature elements may be, for example, token image features corresponding to each image patch of the plurality of image patches that make up the input image 301.

In some embodiments, the plurality of dimensions may include a channel (C) dimension and two spatial dimensions. The channel dimension may be set according to model needs, and each dimension may be used to store different information. The spatial dimension may be the height (H) and width (W) respectively.

The image feature representation 311 extracted by the image encoder 310 is provided to the ranking-based aggregation unit 320. For each image feature element set of a plurality of image feature element sets divided along a predetermined dimension of the plurality of dimensions in the image feature representation 311, the ranking-based aggregation unit 320 may select a first number of image feature elements from the image feature element set based on a ranking of corresponding image feature elements in the image feature element set. In some embodiments, the predetermined dimension includes the channel dimension. For example, if the channel dimension is 1024 (that is, the number of dimensions of the image feature representation 311 is H*W*1024), the ranking-based aggregation unit 320 may divide the image feature representation 311 into 1024 image feature element sets in accordance with the channel dimension, and each image feature element set has H*W image feature elements. For each set on the channel dimension, the ranking-based aggregation unit 320 may rank the H*W image feature elements. The specific way of ranking may be, for example, ranking in a descending order in accordance with a size of value. The ranking-based aggregation unit 320 may select a first number (sometimes also represented as MI in the following embodiments) of image feature elements from the H*W image feature elements.

In some embodiments, since images often contain rich information, the first number selected by the ranking-based aggregation unit 320 is a larger number regardless of the model training stage or the model application stage. In some embodiments, the first number may be different in a training procedure and an application procedure, and may be changed based on actual needs. In some embodiments, in order to further improve the feature aggregation effect of the model in the application stage, the first number may remain the same in the training procedure and the application procedure, and the first number may be changed. For example, the first number may be 5 in both the training procedure and the application procedure, or may be changed to other values. In some embodiments, the first number may be predetermined by relevant staff, or may be determined by the ranking-based aggregation unit 320 based on the actual situation. Therefore, in both the training procedure and the application procedure, the first number may be set based on the amount of information contained in the actual input image, which helps to improve the accuracy of the model in feature extraction and feature aggregation from the image.

The ranking-based aggregation unit 320 may randomly select the first number of image feature elements from the image feature element set or select the first number of image feature elements from the image feature element set in accordance with a certain rule. In order to improve the subsequent feature aggregation effect, in some embodiments, the ranking-based aggregation unit 320 may select the first number of image feature elements that are ranked highly in the image feature element set. For example, the ranking-based aggregation unit 320 may select the highly ranked MI image feature elements from the H*W image feature elements ranked in a descending order in the image feature element set.

The ranking-based aggregation unit 320 may then determine an aggregated image feature element 321 by aggregating the selected first number of image feature elements. For example, the ranking-based aggregation unit 320 may aggregate the selected MI image feature elements to obtain the aggregated image feature element 321. Methods for feature aggregation include, for example, an aggregation method based on an aggregation function, an aggregation method based on deep learning, an aggregation method based on splicing, etc. The embodiments of the present disclosure are not limited in this regard. In some embodiments, the ranking-based aggregation unit 320 may use the more commonly used average aggregation function to determine the aggregated image feature element 321 by averaging MI image feature elements.

The aggregated image feature element 321 are provided to the aggregated feature determination unit 330, which may determine an aggregated image feature representation 331 of the input image 301 based on the plurality of aggregated image feature elements 321 respectively determined for the plurality of image feature element sets. For example, if the channel dimension is 1024 (that is, the number of dimensions of the image feature representation 311 is H*W*1024), the aggregated feature determination unit 330 may aggregate 1024 aggregated image feature elements 321 determined respectively on the 1024 channel dimensions, to obtain the aggregated image feature representation 331 of the input image 301. It may be understood that the aggregation method used here may also be an aggregation method based on an aggregation function, an aggregation method based on deep learning, an aggregation method based on splicing, etc. The embodiments of the present disclosure are not limited in this regard.

In some embodiments, in addition to feature aggregation on the input image 301 to determine its corresponding aggregated image feature representation 331, feature aggregation may also be performed on an input text.

As shown in FIG. 3, similar to the input image 301, an input text 302 is provided to the text encoder 340. The text encoder 340 may extract a text feature representation 342 of the input text 302. The text feature representation 342 may characterize a number, an order, and/or other attributes of the text in the text. Similar to the image encoder 310, the text encoder 340 may also be implemented based on one or more Transformer blocks, various variations of Transformer blocks, or based on other types of models or neural networks, and the embodiments of the present disclosure are not limited in this regard. The text feature representation 342 output by the text encoder 340 corresponds to a plurality of text units of the input text 302, and text feature elements of the text feature representation 342 are logically organized in the plurality of dimensions. The text unit may be, for example, a word, a character, etc. Text feature elements are logically organized in the plurality of dimensions, for example, they may be ranked and combined in accordance with the plurality of dimensions. Text feature element may be, for example, a text feature corresponding to each text unit of the plurality of text units that make up the input text 302. In some embodiments, the text feature representation 342 and the image feature representation 311 may have the same number of dimensions.

The text feature representation 342 extracted by the text encoder 340 is provided to the ranking-based aggregation unit 350. For each text feature element set of a plurality of text feature element sets divided along the predetermined dimension of the plurality of dimensions in the text feature representation 342, the ranking-based aggregation unit 350 may select a second number of text feature elements from the text feature element set based on a ranking of corresponding text feature elements in the text feature element set. Each dimension of the plurality of dimensions may be used to store different information. The predetermined dimension may, for example, indicate the number of text units in the input text 302. For each text feature element set on the predetermined dimension, the ranking-based aggregation unit 350 may rank the plurality of text feature elements it contains. The specific way of ranking may be, for example, ranking in a descending order in accordance with a size of a value. The ranking-based aggregation unit 350 may select a second number (sometimes represented by MT in the following embodiments) of text feature elements from the plurality of text feature elements.

In some embodiments, for example, when the trained image encoder 310 and text encoder 340 are used to implement an image segmentation function without the need for labeled data for image segmentation, although the text encoder 110 may directly obtain the input text 302 during the training procedure, only a text sequence containing “class name” may be obtained during the application procedure. Therefore, although the text information during the training procedure is relatively rich, the information that the text encoder may obtain during the application procedure is very limited. The second number selected by the ranking-based aggregation unit 350 in the training stage may be larger, and the second number selected by the ranking-based aggregation unit 350 in the application stage may be smaller. In some embodiments, the second number is set to a first value during a training procedure of the text encoder, and during an application procedure of the text encoder. The second value is less than the first value. For example, the first value is 5 and the second value is 1. The first value may be changed. For example, the first value may be 5 during the training procedure, or it may be changed to other values. In some embodiments, since the text sequence containing “class name” during the application procedure may only contain one keyword, the second value may be fixedly set to 1. Similar to the first number, the second number may be predetermined by the relevant staff, or may be determined by the ranking-based aggregation unit 350 based on the actual situation. In this way, selecting a larger second number during the training procedure, and setting the value of the second number to 1 during the application procedure, especially when classes are included, will help improve the accuracy of feature extraction and aggregation for text.

The ranking-based aggregation unit 350 may randomly select the second number of text feature elements from the text feature element set or select the second number of text feature elements from the text feature element set in accordance with a certain rule. In order to improve the subsequent feature aggregation effect, in some embodiments, the ranking-based aggregation unit 350 may select the second number of text feature elements that are ranked highly in the text feature element set. For example, the ranking-based aggregation unit 350 may select MT text feature elements that are highly ranked from a plurality of text feature elements ranked in a descending order in the text feature element set.

The ranking-based aggregation unit 350 may then determine an aggregated text feature element 352 by aggregating the selected second number of text feature elements. For example, the ranking-based aggregation unit 350 may aggregate the selected MT text feature elements to obtain the aggregated text feature element 352. Similarly, the aggregation method here may also be based on an aggregation function, such as an aggregation method based on deep learning, an aggregation method based on splicing, etc. The embodiments of the present disclosure are not limited in this regard.

The aggregated text feature element 352 is provided to the aggregated feature determination unit 360, which determines an aggregated text feature representation 362 corresponding to the input text 302 based thereon.

In some embodiments, the architecture 300 further includes an aggregated feature application unit 370 configured to apply the obtained aggregated image feature representation 331 and aggregated text feature representation 362.

For example, the aggregated image feature representation 331 and aggregated text feature representation 362 may be applied in a pre-training stage of the model. The aggregated feature application unit 370 may determine a contrastive learning loss between the aggregated image feature representation 331 and the aggregated text feature representation 362 representation with a loss function. The parameters of image encoder 310 and text encoder 340 may be adjusted based on the contrastive learning loss obtained by the aggregated feature application unit. As a result, the model may learn a method for feature aggregation driven by local fine-grained feature alignment in the pre-training stage of the model, which helps to improve the model's sensitivity to foreground objects in the image.

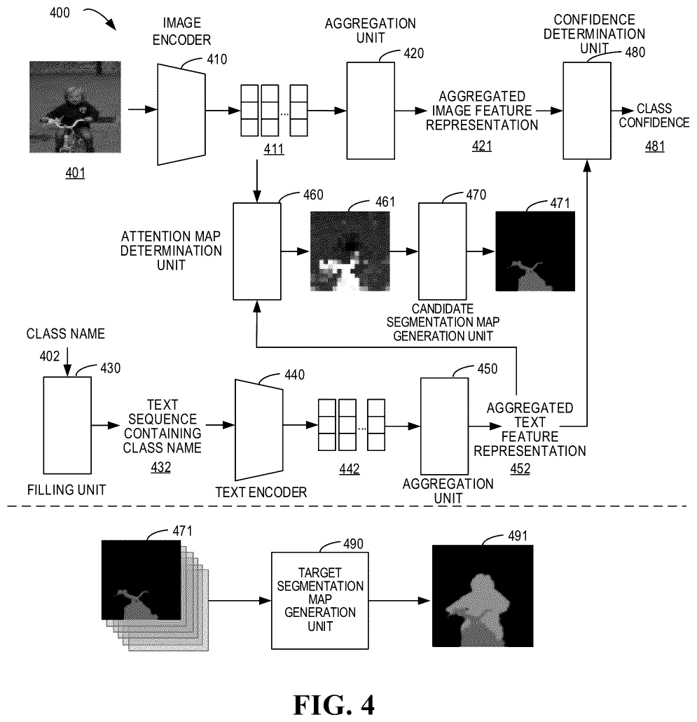

As an alternative or in addition, the aggregated image feature representation 331 and the aggregated text feature representation 362 may further be applied in the application stage and/or the testing stage of the model. For example, the aggregated feature application unit 370 may process the aggregated image feature representation 331 and the aggregated text feature representation 362 to apply to an image segmentation scenario. It should be noted that the model may obtain sample data containing sample image-text pair in the pre-training stage. The input image of the model is an unlabeled sample image used for training. However, in the application stage and/or testing stage, the model may only obtain a target image to be used for feature aggregation. Example embodiments in the application stage and/or testing stage of the model are described below with reference to FIG. 4.

FIG. 4 illustrates a schematic diagram of an architecture 400 for image segmentation according to some embodiments of the present disclosure. An image encoder 410 and a text encoder 440 shown in FIG. 4 may respectively correspond to the image encoder 310 and text encoder 340 shown in FIG. 3. An aggregation unit 420 shown in FIG. 4 may correspond to the ranking-based aggregation unit 320 and the aggregated feature determination unit 330 shown in FIG. 3. An aggregation unit 450 shown in FIG. 4 may correspond to the ranking-based aggregation unit 350 and the aggregated feature determination unit 360 shown in FIG. 3. An attention map determination unit 460, a candidate segmentation map generation unit 470, a confidence determination unit 480 and a target segmentation map generation unit 490 shown in FIG. 4 may correspond to the aggregated feature application unit 370 shown in FIG. 3.

As shown in FIG. 4, the image encoder 410 may extract an image feature representation 411 for an input target image 401. The image feature representation 411 is provided to the aggregation unit 420. The aggregation unit 420 may be implemented according to the embodiments discussed above regarding image feature aggregation. Specifically, for each image feature element set of a plurality of image feature element sets divided along a predetermined dimension of the plurality of dimensions in the image feature representation 411, the aggregation unit 420 selects MI image feature elements from the image feature element set based on a ranking of corresponding image feature elements in the image feature element set, and determines an aggregated image feature element by aggregating the selected MI image feature elements. The aggregation unit 420 may also determine an aggregated image feature representation 421 of the target image 401 based on a plurality of aggregated image feature elements respectively determined for the plurality of image feature element sets.

In some embodiments, a class set associated with the target image 401 may be obtained in advance, and this set may contain all classes associated with the target image 401. For each class in the class set, at least one class name 402 is provided to a filling unit 430. The class name 402 may be, for example, “fruit”, “bicycle”, “animal”, “shoes”, etc. The filling unit 430 may generate at least one text sequence 432 containing “class name” by respectively filling the class name 402 into at least one prompt word template. Specifically, for each class, the filling unit 430 may fill the class name 402 into at least one prompt word template through prompt engineering to obtain at least one text sequence 432 containing “class name”. Taking the class name 402 as “bicycle” as an example, the filling unit 420 may fill “bicycle” into at least one prompt word template to obtain a plurality of text sequences. The plurality of text sequences may be, for example, “pictures of bicycles”, “oil paintings of bicycles”, “a bicycle”, etc. In some embodiments, at least one prompt word template contains a plurality of different prompt word templates. Therefore, at least one text sequence 432 containing “class name” may contain a plurality of different text sequences, and each text sequence includes the class name. In this way, using different prompt word templates to generate different text sequences may achieve diversified language expressions of class names, which helps to improve the accuracy of subsequent feature extraction by the text encoder 440.

The text encoder 440 may obtain the text sequence 432 containing the “class name” and generate the corresponding text feature representation 442 based on the text sequence 432 containing the “class name”.

The text feature representation 442 is provided to the aggregation unit 450. The aggregation unit 450 may be implemented according to the embodiments discussed above regarding text feature aggregation. Specifically, for each text feature element set of a plurality of text feature element sets divided along the predetermined dimension of the plurality of dimensions in the text feature representation 442, the aggregation unit 450 may select MT text feature elements from the text feature element set based on a ranking of corresponding text feature elements in the text feature element set, and determine an aggregated text feature element by aggregating the selected MT text feature elements. The aggregation unit 450 may also determine an aggregated text feature representation 452 corresponding to the class based on a plurality of aggregated text feature elements respectively determined for the plurality of text feature element sets, respectively.

In some embodiments, the image feature representation 411 is provided to the attention map determination unit 460 together with the aggregated text feature representation 452 corresponding to the class. The attention map determination unit 460 is configured to determine an attention map 461 based on the aggregated text feature representation 452 and image feature representation 411. As an example, the attention map determination unit 460 may perform an inner product on the aggregated text feature representation 452 and the image feature representation 411 to obtain the attention map 461.

The attention map 461 is provided to the candidate segmentation map generation unit 470, which may generate a candidate segmentation map 471 by processing the attention map 461. In some embodiments, the candidate segmentation map generation unit 450 may up-sample the attention map 461 to a size corresponding to the target image 401 to obtain the up-sampled attention map 461. The candidate segmentation map generation unit 470 may optimize the up-sampled attention map 461 through a CRF process, determine a class corresponding to each pixel in the target image, and then output the candidate segmentation map 471.

The confidence determination unit 480 may calculate the aggregated image feature representation 421 and the aggregated text feature representation 452 corresponding to the class, and the calculated result may indicate a class confidence 481 of the class. For example, the confidence determination unit 480 may perform an inner product on the aggregated image feature representation 421 and the aggregated text feature representation 452 corresponding to the class to obtain the class confidence 481 corresponding to the class.

The candidate segmentation map 471 and class confidence 481 corresponding to a plurality of classes are provided to the target segmentation map generation unit 490. The target segmentation map generation unit 490 is configured to select at least one class related to the target image 401 from a plurality of classes based on a plurality of class confidences 381 respectively determined for the plurality of classes. The target segmentation map generation unit 490 is further configured to determine a target segmentation map 491 for the target image 401 based on the candidate segmentation map 471 and the class confidence 481 determined for the selected at least one class. The target segmentation map 491 may indicate whether a corresponding pixel in the target image 401 belongs to a class of the at least one class.

In this way, the aggregated image feature representation obtained by feature aggregation may be made more sensitive to the foreground elements in the input image, thereby improving the accuracy of the aggregated features, and also improving the segmentation effect of subsequent image segmentation in the model application stage.

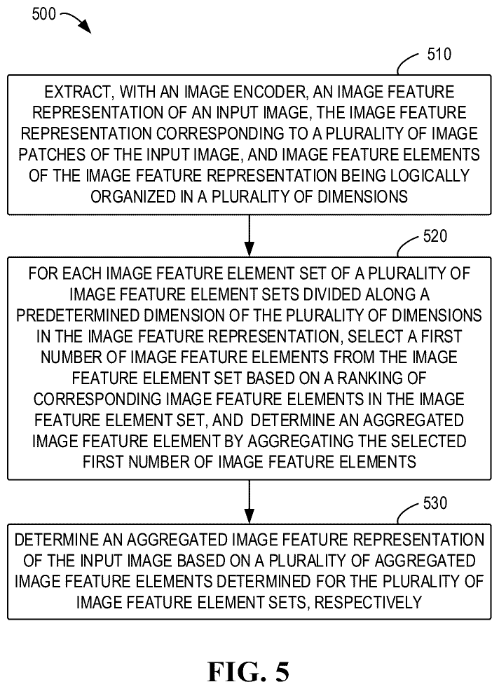

FIG. 5 illustrates a flowchart of a process 500 for feature aggregation according to some embodiments of the present disclosure. The process 500 may be implemented at the electronic device 110, for example. For ease of discussion, the process 500 will be described with reference to the environment 100 of FIG. 1.

At block 510, the electronic device 110 extracts, with an image encoder, an image feature representation of an input image. The image feature representation corresponds to a plurality of image patches of the input image, and image feature elements of the image feature representation are logically organized in a plurality of dimensions.

At block 520, the electronic device 110, for each image feature element set of a plurality of image feature element sets divided along a predetermined dimension of the plurality of dimensions in the image feature representation, selects a first number of image feature elements from the image feature element set based on a ranking of corresponding image feature elements in the image feature element set, and determines an aggregated image feature element by aggregating the selected first number of image feature elements.

At block 530, the electronic device 110 determines an aggregated image feature representation of the input image based on a plurality of aggregated image feature elements determined for the plurality of image feature element sets, respectively.

In some embodiments, for each image feature element set in the plurality of image feature element sets, the image feature elements are ranked in an order from large to small in value, and selecting the first number of image feature elements from the image feature element set comprises: selecting the first number of image feature elements that are ranked highly in the image feature element set.

In some embodiments, the plurality of dimensions comprises a channel dimension and two spatial dimensions, and the predetermined dimension comprises the channel dimension.

In some embodiments, determining the aggregated image feature element comprises: determining the aggregated image feature element by averaging the first number of image feature elements.

In some embodiments, the first number remains the same during a training procedure and an application procedure of the image encoder.

In some embodiments, the process 500 also includes: extracting, with a text encoder, a text feature representation of an input text, the text feature representation corresponding to a plurality of text units of the input text, and text feature elements of the text feature representation being logically organized in the plurality of dimensions; for each text feature element set of a plurality of text feature element sets divided along the predetermined dimension of the plurality of dimensions in the text feature representation, selecting a second number of text feature elements from the text feature element set based on a ranking of corresponding text feature elements in the text feature element set, and determining an aggregated text feature element by aggregating the selected second number of text feature elements; and determining an aggregated text feature representation of the input text based on a plurality of aggregated text feature elements determined for the plurality of text feature element sets, respectively.

In some embodiments, for each text feature element set in the plurality of text feature element sets, the text feature elements are ranked in an order from large to small in value, and selecting the second number of text feature elements from the text feature element set comprises: selecting the second number of text feature elements that are ranked highly in the text feature element set.

In some embodiments, the second number is set to a first value during a training procedure of the text encoder, and is set to a second value during an application procedure of the text encoder, the second value is less than the first value.

In some embodiments, the input text is determined based on a name of a given class among a plurality of categories used for image segmentation, and the method further comprises: determining, based on the image feature representation and the text feature representation, a candidate segmentation map for the input image and a class confidence for the given class, the candidate segmentation map indicating whether a corresponding pixel in the input image belongs to the given class; and determining a target segmentation map for the target image based on at least the candidate segmentation map and the class confidence.

In some embodiments, a value of the second number is set to one.

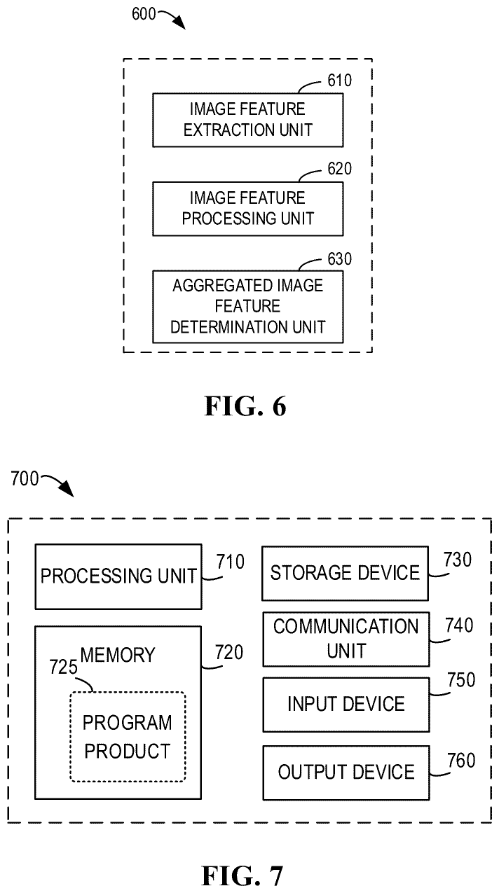

FIG. 6 illustrates a schematic structural block diagram of an apparatus 600 for feature aggregation according to some embodiments of the present disclosure. The apparatus 600 may be implemented as or included in the electronic device 110. Each unit/component in the apparatus 600 may be implemented by hardware, software, firmware, or any combination thereof.

As shown in the figure, the apparatus 600 includes an image feature extraction unit 610 configured for extracting, with an image encoder, an image feature representation of an input image, the image feature representation corresponding to a plurality of image patches of the input image, and image feature elements of the image feature representation being logically organized in a plurality of dimensions. The apparatus 600 further includes an image feature processing unit 620 configured for, for each image feature element set of a plurality of image feature element sets divided along a predetermined dimension of the plurality of dimensions in the image feature representation, selecting a first number of image feature elements from the image feature element set based on a ranking of corresponding image feature elements in the image feature element set, and determining an aggregated image feature element by aggregating the selected first number of image feature elements. The apparatus 600 further includes an aggregated image feature determination unit 630 configured for determining an aggregated image feature representation of the input image based on a plurality of aggregated image feature elements determined for the plurality of image feature element sets, respectively.

In some embodiments, the image feature processing unit 620 is further configured to select the first number of image feature elements that are ranked highly in the image feature element set.

In some embodiments, the plurality of dimensions comprises a channel dimension and two spatial dimensions, and the predetermined dimension comprises the channel dimension.

In some embodiments, the image feature processing unit 620 is further configured to determine the aggregated image feature element by averaging the first number of image feature elements.

In some embodiments, the first number remains the same during a training procedure and an application procedure of the image encoder.

In some embodiments, the apparatus 600 further includes: a text feature extraction unit configured to extract, with a text encoder, a text feature representation of an input text, the text feature representation corresponding to a plurality of text units of the input text, and text feature elements of the text feature representation being logically organized in the plurality of dimensions; a text feature processing unit configured to, for each text feature element set of a plurality of text feature element sets divided along the predetermined dimension of the plurality of dimensions in the text feature representation, select a second number of text feature elements from the text feature element set based on a ranking of corresponding text feature elements in the text feature element set, and determines an aggregated text feature element by aggregating the selected second number of text feature elements; and a text feature determination unit configured to determine an aggregated text feature representation of the input text based on a plurality of aggregated text feature elements determined for the plurality of text feature element sets, respectively.

In some embodiments, the text feature processing unit is further configured to select the second number of text feature elements that are ranked highly in the text feature element set.

In some embodiments, the second number is set to a first value during a training procedure of the text encoder, and is set to a second value during an application procedure of the text encoder, the second value is less than the first value.

In some embodiments, the input text is determined based on a name of a given class among a plurality of categories used for image segmentation, and the apparatus 600 further includes: a determination unit configured to determine, based on the image feature representation and the text feature representation, a candidate segmentation map for the input image and a class confidence for the given class, the candidate segmentation map indicating whether a corresponding pixel in the input image belongs to the given class; and a target segmentation map determination unit configured to determine a target segmentation map for the target image based on at least the candidate segmentation map and the class confidence.

In some embodiments, a value of the second number is set to one.

FIG. 7 illustrates a block diagram of an electronic device 700 capable of implementing multiple implementations of the disclosure. It should be understood that the electronic device 700 shown in FIG. 7 is merely exemplary and should not constitute any limitation on the functionality and scope of the implementations described herein. The electronic device 700 shown in FIG. 7 may be used to implement the electronic device 110 in FIG. 1.

As shown in FIG. 7, the electronic device 700 is in the form of a general electronic device. The components of electronic device 700 may include, but are not limited to, one or more processors or processing units 710, a memory 720, a storage device 730, one or more communication units 740, one or more input devices 750, and one or more output devices 760. The processing unit 710 may be an actual or virtual processor and can execute various processes based on the programs stored in the memory 720. In a multiprocessor system, multiple processing units execute computer executable instructions in parallel to improve the parallel processing capability of the electronic device 700.

The electronic device 700 typically includes multiple computer storage medium. Such medium may be any available medium that is accessible to the electronic device 700, including but not limited to volatile and non-volatile medium, removable and non-removable medium. The memory 720 may be volatile memory (for example, a register, cache, a random access memory (RAM)), a non-volatile memory (for example, a read-only memory (ROM), an electrically erasable programmable read-only memory (EEPROM), a flash memory), or any combination thereof. The storage device 730 may be any removable or non-removable medium, and may include a machine readable medium such as a flash drive, a disk, or any other medium, which may be used to store information and/or data (such as training data for training) and may be accessed within the electronic device 700.

The electronic device 700 may further include additional removable/non-removable, volatile/non-volatile storage medium. Although not shown in FIG. 7, a disk driver for reading from or writing to a removable, non-volatile disk (such as a “floppy disk”), and an optical disk driver for reading from or writing to a removable, non-volatile optical disk may be provided. In these cases, each driver may be connected to the bus (not shown) by one or more data medium interfaces. The memory 720 may include a computer program product 725, which has one or more program units configured to execute various methods or acts of various implementations of the present disclosure.

The communication unit 740 communicates with a further electronic device through the communication medium. In addition, functionality of components in the electronic device 700 may be implemented by a single computing cluster or multiple computing machines, which can communicate through a communication connection. Therefore, the electronic device 700 may be operated in a networking environment using a logical connection with one or more other servers, a network personal computer (PC), or another network node.

The input device 750 may be one or more input devices, such as a mouse, a keyboard, a trackball, etc. The output device 760 may be one or more output devices, such as a display, a speaker, a printer, etc. The electronic device 700 may also communicate with one or more external devices (not shown) through the communication unit 740 as required. The external device, such as a storage device, a display device, etc., communicate with one or more devices that enable users to interact with the electronic device 700, or communicate with any device (for example, a network card, a modem, etc.) that makes the electronic device 700 communicate with one or more other electronic devices. Such communication may be executed via an input/output (I/O) interface (not shown).

According to the example implementations of the present disclosure, a computer-readable storage medium is provided, on which a computer-executable instruction or computer program is stored, wherein the computer-executable instructions is executed by the processor to implement the method described above. According to the example implementations of the present disclosure, a computer program product is also provided. The computer program product is physically stored on a non-transient computer-readable medium and includes computer-executable instructions, which are executed by the processor to implement the method described above. According to the exemplary implementations of the present disclosure, a computer program product is provided having stored thereon a computer program, and when the program is executed by a processor, the method described above is implemented.

Various aspects of the present disclosure are described herein with reference to the flow chart and/or the block diagram of the method, the apparatus, the device and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, specialized computers, or other programmable data processing devices to produce a machine that generates an apparatus to implement the functions/actions specified in one or more blocks in the flow chart and/or the block diagram when these instructions are executed through the computer or other programmable data processing apparatuses. These computer-readable program instructions may also be stored in a computer-readable storage medium. These instructions enable a computer, a programmable data processing apparatus and/or other devices to work in a specific way. Therefore, the computer-readable medium containing the instructions includes a product, which includes instructions to implement various aspects of the functions/actions specified in one or more blocks in the flowchart and/or the block diagram.

The computer-readable program instructions may be loaded onto a computer, other programmable data processing apparatus, or other devices, so that a series of operational steps may be executed on a computer, other programmable data processing apparatus, or other devices, to generate a computer-implemented process, such that the instructions which execute on a computer, other programmable data processing apparatuses, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a unit, a program segment or instructions, which contains one or more executable instructions for implementing the specified logic function. In some alternative implementations, the functions labeled in the block may also occur in a different order from those labeled in the drawings. For example, two consecutive blocks may actually be executed in parallel, and sometimes can also be executed in a reverse order, depending on the functionality involved. It should also be noted that each block in the block diagram and/or the flowchart, and combinations of blocks in the block diagram and/or the flowchart, may be implemented by a dedicated hardware-based system that executes the specified functions or acts, or by the combination of dedicated hardware and computer instructions.

Each implementation of the present disclosure has been described above. The above description is an example, not exhaustive, and is not limited to the disclosed implementations. Without departing from the scope and spirit of the described implementations, many modifications and changes are obvious to ordinary skill in the art. The selection of terms used in the present disclosure aims to best explain the principles, practical application or improvement of technology in the market of each implementation, or to enable other ordinary skill in the art to understand the various implementations disclosed herein.

1. A method for feature aggregation comprising:
extracting, with an image encoder, an image feature representation of an input image, the image feature representation corresponding to a plurality of image patches of the input image, and image feature elements of the image feature representation being logically organized in a plurality of dimensions;
for each image feature element set of a plurality of image feature element sets divided along a predetermined dimension of the plurality of dimensions in the image feature representation,
selecting a first number of image feature elements from the image feature element set based on a ranking of corresponding image feature elements in the image feature element set, and
determining an aggregated image feature element by aggregating the selected first number of image feature elements; and
determining an aggregated image feature representation of the input image based on a plurality of aggregated image feature elements determined for the plurality of image feature element sets, respectively.

2. The method of claim 1, wherein for each image feature element set in the plurality of image feature element sets, the image feature elements are ranked in an order from large to small in value, and selecting the first number of image feature elements from the image feature element set comprises:
selecting the first number of image feature elements that are ranked highly in the image feature element set.

3. The method of claim 1, wherein the plurality of dimensions comprises a channel dimension and two spatial dimensions, and the predetermined dimension comprises the channel dimension.

4. The method of claim 1, wherein determining the aggregated image feature element comprises:
determining the aggregated image feature element by averaging the first number of image feature elements.

5. The method of claim 1, wherein the first number remains the same during a training procedure and an application procedure of the image encoder.

6. The method of claim 1, further comprising:
extracting, with a text encoder, a text feature representation of an input text, the text feature representation corresponding to a plurality of text units of the input text, and text feature elements of the text feature representation being logically organized in the plurality of dimensions;
for each text feature element set of a plurality of text feature element sets divided along the predetermined dimension of the plurality of dimensions in the text feature representation,
selecting a second number of text feature elements from the text feature element set based on a ranking of corresponding text feature elements in the text feature element set, and
determining an aggregated text feature element by aggregating the selected second number of text feature elements; and
determining an aggregated text feature representation of the input text based on a plurality of aggregated text feature elements determined for the plurality of text feature element sets, respectively.

7. The method of claim 6, wherein for each text feature element set in the plurality of text feature element sets, the text feature elements are ranked in an order from large to small in value, and selecting the second number of text feature elements from the text feature element set comprises:
selecting the second number of text feature elements that are ranked highly in the text feature element set.

8. The method of claim 6, wherein the second number is set to a first value during a training procedure of the text encoder, and is set to a second value during an application procedure of the text encoder, the second value is less than the first value.

9. The method of claim 6, wherein the input text is determined based on a name of a given class among a plurality of categories used for image segmentation, and the method further comprises:
determining, based on the image feature representation and the text feature representation, a candidate segmentation map for the input image and a class confidence for the given class, the candidate segmentation map indicating whether a corresponding pixel in the input image belongs to the given class; and
determining a target segmentation map for the target image based on at least the candidate segmentation map and the class confidence.

10. The method of claim 9, wherein a value of the second number is set to one.

11. An electronic device comprising:
at least one processing unit; and
at least one memory coupled to the at least one processing unit and storing instructions for execution by the at least one processing unit, the instructions when executed by the at least one processing unit causing the electronic device to perform actions for feature aggregation, the actions comprising:
extracting, with an image encoder, an image feature representation of an input image, the image feature representation corresponding to a plurality of image patches of the input image, and image feature elements of the image feature representation being logically organized in a plurality of dimensions;
for each image feature element set of a plurality of image feature element sets divided along a predetermined dimension of the plurality of dimensions in the image feature representation,
selecting a first number of image feature elements from the image feature element set based on a ranking of corresponding image feature elements in the image feature element set, and
determining an aggregated image feature element by aggregating the selected first number of image feature elements; and
determining an aggregated image feature representation of the input image based on a plurality of aggregated image feature elements determined for the plurality of image feature element sets, respectively.

12. The device of claim 11, wherein for each image feature element set in the plurality of image feature element sets, the image feature elements are ranked in an order from large to small in value, and selecting the first number of image feature elements from the image feature element set comprises:
selecting the first number of image feature elements that are ranked highly in the image feature element set.

13. The device of claim 11, wherein the plurality of dimensions comprises a channel dimension and two spatial dimensions, and the predetermined dimension comprises the channel dimension.

14. The device of claim 11, wherein determining the aggregated image feature element comprises:
determining the aggregated image feature element by averaging the first number of image feature elements.

15. The device of claim 11, wherein the first number remains the same during a training procedure and an application procedure of the image encoder.

16. The device of claim 11, further comprising:
extracting, with a text encoder, a text feature representation of an input text, the text feature representation corresponding to a plurality of text units of the input text, and text feature elements of the text feature representation being logically organized in the plurality of dimensions;
for each text feature element set of a plurality of text feature element sets divided along the predetermined dimension of the plurality of dimensions in the text feature representation,
selecting a second number of text feature elements from the text feature element set based on a ranking of corresponding text feature elements in the text feature element set, and
determining an aggregated text feature element by aggregating the selected second number of text feature elements; and
determining an aggregated text feature representation of the input text based on a plurality of aggregated text feature elements determined for the plurality of text feature element sets, respectively.

17. The device of claim 16, wherein for each text feature element set in the plurality of text feature element sets, the text feature elements are ranked in an order from large to small in value, and selecting the second number of text feature elements from the text feature element set comprises:
selecting the second number of text feature elements that are ranked highly in the text feature element set.

18. The device of claim 16, wherein the second number is set to a first value during a training procedure of the text encoder, and is set to a second value during an application procedure of the text encoder, the second value is less than the first value.

19. The device of claim 16, wherein the input text is determined based on a name of a given class among a plurality of categories used for image segmentation, and the actions further comprise:
determining, based on the image feature representation and the text feature representation, a candidate segmentation map for the input image and a class confidence for the given class, the candidate segmentation map indicating whether a corresponding pixel in the input image belongs to the given class; and
determining a target segmentation map for the target image based on at least the candidate segmentation map and the class confidence.

20. A non-transitory computer readable storage medium having stored thereon a computer program, when executed by a processor, implementing actions for feature aggregation, the actions comprising:
extracting, with an image encoder, an image feature representation of an input image, the image feature representation corresponding to a plurality of image patches of the input image, and image feature elements of the image feature representation being logically organized in a plurality of dimensions;
for each image feature element set of a plurality of image feature element sets divided along a predetermined dimension of the plurality of dimensions in the image feature representation,
selecting a first number of image feature elements from the image feature element set based on a ranking of corresponding image feature elements in the image feature element set, and
determining an aggregated image feature element by aggregating the selected first number of image feature elements; and
determining an aggregated image feature representation of the input image based on a plurality of aggregated image feature elements determined for the plurality of image feature element sets, respectively.
